(19) United States
(12) Patent Application Publication
(10) Pub. No.: US 2025/0172839 A1
(43) Pub. Date: May 29, 2025

(54) DISPLAY SUBSTRATE AND LIQUID CRYSTAL DISPLAY PANEL

(71) Applicant: TCL CHINA STAR OPTOELECTRONICS TECHNOLOGY CO., LTD., Shenzhen (CN)

(72) Inventors: Cuiying CHEN, Shenzhen (CN); Yani CHEN, Shenzhen (CN)

(73) Assignee: TCL CHINA STAR OPTOELECTRONICS TECHNOLOGY CO., LTD., Shenzhen (CN)

(21) Appl. No.: 18/963,474

(22) Filed: Nov. 27, 2024

(30) Foreign Application Priority Data
Nov. 28, 2023 (CN) 202311624725.3

(51) Int. Cl. G02F 1/1343; G02F 1/1335

(52) U.S. Cl. CPC G02F 1/134309; G02F 1/133514

(57) ABSTRACT

Provided is a display substrate and a liquid crystal display panel. The display substrate includes an array substrate, a first electrode layer, an insulation layer, and a second electrode layer arranged in sequence, the first electrode layer includes a plurality of first electrodes arranged spaced apart from each other, at least two adjacent first electrodes are insulated from each other, and the second electrode layer includes a plurality of second electrodes arranged spaced apart from each other, and the plurality of second electrodes are arranged in a one-to-one correspondence with the plurality of first electrodes.

### CROSS-REFERENCE TO RELATED APPLICATIONS

The present disclosure claims priority to Chinese Patent Application No. 202311624725.3, filed in the China National Intellectual Property Administration on Nov. 28, 2023, the disclosure of which is incorporated herein by reference in its entirety.

### TECHNICAL FIELD

The present disclosure relates to a field of display, and in particular to a display substrate and a liquid crystal display panel.

### BACKGROUND

With the development of a technology of active thin film transistor liquid crystal display (Thin Film Transistor-LCD, TFT-LCD), a size of a display screen thereof becomes greater and greater, and people's demand for the quality of liquid crystal display panel, especially, the demand for a wider viewing angle range, is also increasing. In order to improve the viewing angle performance of the liquid crystal display panel, a pixel in a display substrate thereof is divided into a plurality of domains by using multi-domain vertical alignment technology, and the liquid crystal in each domain is oriented in different directions after a voltage is applied thereto, so that the display effects in respective directions tend to be uniform and even. However, the pressure design of the existing display substrate when controlling the deflection of the liquid crystal makes the viewing angle of the display substrate limited, and still cannot fully meet the increasing the demand of the consumer for viewing angle.

### SUMMARY

An embodiment of the present disclosure provides a display substrate and a liquid crystal display panel.

An embodiment of the present disclosure provides a display substrate, which is applied to a liquid crystal display panel, and the display substrate includes:
an array substrate;
a first electrode layer disposed at a side of the array substrate, wherein the first electrode layer comprises a plurality of first electrodes arranged spaced apart from each other, and at least two adjacent ones of the plurality of first electrodes are insulated from each other;
an insulation layer disposed at a side of the first electrode layer away from the array substrate; and
a second electrode layer disposed at a side of the insulation layer away from the first electrode layer, wherein the second electrode layer comprises a plurality of second electrodes arranged spaced apart from each other, and the plurality of second electrodes are arranged in one-to-one correspondence with the plurality of first electrodes.

Alternatively, in some embodiments of the present disclosure, the display substrate comprises a color photoresist layer, the color photoresist layer is located between the array substrate and the first electrode layer, the color photoresist layer comprises a plurality of color photoresists, the plurality of color photoresists are arranged in a one-to-one correspondence with the plurality of first electrodes, and ones of the plurality of first electrodes corresponding to at least two adjacent ones of the plurality of color photoresists having different colors are insulated from each other.

Alternatively, in some embodiments of the present disclosure, ones of the plurality of first electrodes corresponding to any two adjacent ones of the color photoresists having different colors are insulated from each other.

Alternatively, in some embodiments of the present disclosure, ones of the plurality of first electrodes corresponding to at least two ones of the color photoresists having the same color are insulated from each other; and/or ones of the plurality of first electrodes corresponding to at least two ones of the color photoresists having the same color are electrically connected to each other.

Alternatively, in some embodiments of the present disclosure, the second electrode comprises a main electrode and one or more branch electrodes connected to each other, a plurality of domains are enclosed by the main electrode, the branch electrode is located within at least one of the domains, and the branch electrode in one of two adjacent ones of the domains form an angle relative to the branch electrode in other of the two adjacent ones of the domains, and an orthographic projection of the first electrode on the array substrate at least covers an orthographic projection of the main electrode of the second electrode on the array substrate.

Alternatively, in some embodiments of the present disclosure, a plurality of hollow regions are formed in the first electrode, and the plurality of hollow regions are arranged in a one-to-one correspondence with the plurality of domains in the second electrode.

Alternatively, in some embodiments of the present disclosure, more than one of the one or more branch electrodes are arranged in parallel in the domain, a spacing is provided between two adjacent ones of the one or more branch electrodes, and the hollow region in the first electrode is provided corresponding to the spacing between two adjacent ones of the branch electrodes in the second electrode.

Alternatively, in some embodiments of the present disclosure, an orthographic projection of the first electrode on the array substrate covers the orthographic projections of the main electrode and the branch electrodes of the second electrode on the array substrate.

Alternatively, in some embodiments of the present disclosure, the first electrode and the second electrode are transparent electrodes.

Accordingly, an embodiment of the present disclosure further provides a liquid crystal display panel, including:
the display substrate as described in any one of the above embodiments;
an opposing substrate, arranged opposite to the display substrate, and located at a side of the second electrode layer of the display substrate away from the array substrate; and
a liquid crystal layer filled between the display substrate and the opposing substrate.

In an embodiment of the present disclosure, the display substrate includes an array substrate, a first electrode layer, an insulation layer, and a second electrode layer, which are sequentially arranged. The first electrode layer includes a plurality of first electrodes arranged spaced apart from each other, and at least two adjacent first electrodes are insulated from each other. The second electrode layer includes a plurality of second electrodes arranged spaced apart from each other, and the plurality of second electrodes are arranged in a one-to-one correspondence with the plurality of first electrodes. The first electrode layer is disposed between the array substrate and the insulation layer, and at least two adjacent first electrodes are insulated from each other. Therefore, different voltages may be input to the two first electrodes respectively, thereby forming different voltage differences and different electric fields with the corresponding second electrodes, respectively, thereby controlling the corresponding liquid crystal to deflect to different angles, to improve the viewing angle of the display substrate.

### BRIEF DESCRIPTION OF THE DRAWINGS

To more clearly illustrate technical solutions in the embodiments of the present disclosure, the drawings required for the description of the embodiments will be briefly introduced below. The drawings described below are only some embodiments of the present disclosure. For those skilled in the art, other drawings may be obtained based on these drawings without providing any creative work.

FIG. 1 is a schematic block diagram of a display substrate according to an embodiment of the present disclosure;

FIG. 2 is a schematic block of a film layer of a display substrate according to an embodiment of the present disclosure;

FIG. 3 is a schematic block diagram of a first electrode layer according to an embodiment of the present disclosure;

FIG. 4 is a schematic diagram of electric field distribution of a display substrate according to an embodiment of the present disclosure;

FIG. 5 is a schematic block diagram of a liquid crystal display panel according to an embodiment of the present disclosure.

### DESCRIPTION OF REFERENCE NUMERALS

| | | |
|---|---|---|
| 10, liquid crystal display panel; | 100, display substrate; | 110, array substrate; |
| 111, substrate layer; | 112, gate layer; | 113, gate insulation layer; |
| 114, active layer; | 115, source-drain layer; | 116, passivation layer; |
| 120, color photoresist layer; | 130, first electrode layer; | 131, first electrode; |
| 132, hollow region; | 140, insulation layer; | 150, second electrode layer; |
| 151, second electrode; | 1511, main electrode; | 1512, branch electrode; |
| 1513, domain region; | 200, an opposing substrate; | 300, liquid crystal layer; and |
| 310, liquid crystal. | | |

### DETAILED DESCRIPTION

Technical solutions in embodiments of the present disclosure will be clearly and completely described below in conjunction with drawings in the embodiments of the present disclosure. The described embodiments are only a part of embodiments of the present disclosure, rather than all the embodiments. Based on the embodiments in the present disclosure, all other embodiments obtained by those skilled in the art without creative work fall within the scope of the present disclosure. In addition, it should be understood that the specific implementations described herein are only used to illustrate and explain the present disclosure, and are not used to limit the present disclosure. In the present disclosure, unless otherwise stated, directional words used such as “upper” and “lower” generally refer to the upper and lower directions of the device in actual use or working state, and specifically refer to the drawing directions in the drawings; and “inner” and “outer” refer to the outline of the device.

An embodiment of the present disclosure provides a display substrate and a liquid crystal display panel, which are described in detail below. It should be noted that the order of description of the following embodiments is not intended to limit the preferred order of the embodiments.

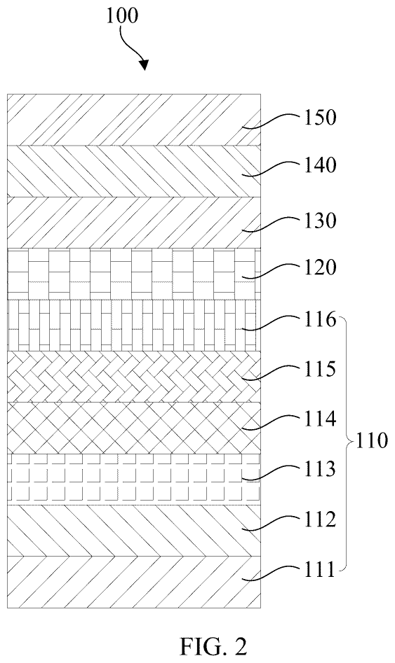

An embodiment of the present disclosure provides a display substrate. As shown in FIG. 2, the display substrate 100 includes an array substrate 110. The array substrate 110 serves as a base structure of the display substrate 100 and is used to support other functional structural layers in the display substrate 100 to ensure the overall structural stability of the display substrate 100.

The array substrate 110 includes basic structures such as a substrate layer 111, a gate layer 112, a gate insulation layer 113, an active layer 114, a source-drain layer 115, and a passivation layer 116 which are sequentially arranged in a vertical direction perpendicular to a lower surface of the array substrate 110. The gate layer 112, the gate insulation layer 113, the active layer 114 and the source-drain layer 115 constitute a thin film transistor layer. The thin film transistor layer has a plurality of thin film transistors. By controlling the turn-on or turn-off of the thin film transistors, on or off of an input signal input to the thin film transistor may be controlled, thereby controlling the display of the display substrate 100.

The display substrate 100 includes a first electrode layer 130 and a second electrode layer 150, and an insulation layer 140 disposed between the first electrode layer 130 and the second electrode layer 150. The insulation layer 140 is configured to separate the first electrode layer 130 from the second electrode layer 150 to avoid the short circuit or signal interference between the first electrode layer 130 and the second electrode layer 150.

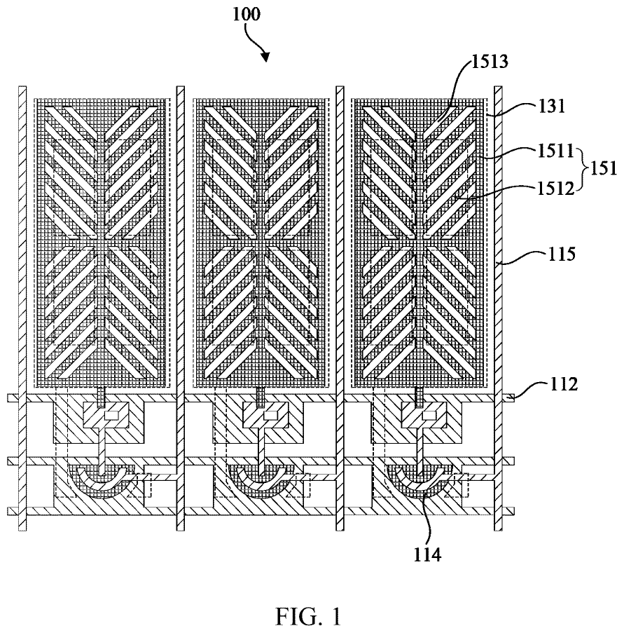

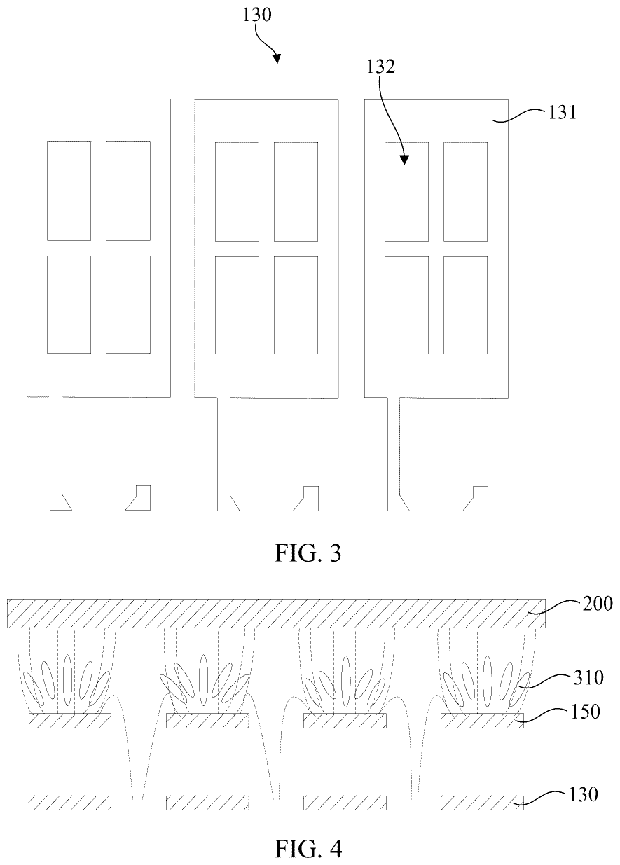

As shown in FIGS. 1 and 3, the first electrode layer 130 is arranged at a side of the array substrate 110 in the vertical direction, and the first electrode layer 130 includes a plurality of first electrodes 131 arranged spaced apart from each other, and the first electrode 131 is a common electrode for inputting a first voltage. The second electrode layer 150 includes a plurality of second electrodes 151 arranged spaced apart from each other, and the second electrode 151 is a pixel electrode for inputting a second voltage. The plurality of second electrodes 151 are arranged in a one-to-one correspondence with the plurality of first electrodes 131, and the deflection angle of the liquid crystal molecule 310 may be controlled by the cooperation of the second electrodes 151 and the first electrodes 131 and the voltage input.

It should be noted that the first electrode layer 130 is arranged at a side of the array substrate 110 in an embodiment of the present disclosure, which only describes the relative position between the first electrode layer 130 and the array substrate 110, and does not only mean that the first electrode layer 130 is arranged directly on the array substrate 110. One or more other film layers may further be arranged between the first electrode layer 130 and the array substrate 110 according to actual design requirements, and the present disclosure is not limited thereto.

At least two adjacent first electrodes are insulated from each other, that is, the first voltages respectively input to the at least two adjacent first electrodes may be controlled separately, so that the first voltages respectively input to the at least two adjacent first electrodes are different from each other. Therefore, different voltage differences are formed between the at least two adjacent first electrodes 131 and the second electrodes 151 respectively corresponding to the at least two adjacent first electrodes 131. That is, the driving force and the action direction of the electric field generated between one of the at least two adjacent second electrodes 151 and the first electrode 131 corresponding to the second electrode 151 is different from the driving force and the action direction of the electric field generated between other of the at least two adjacent second electrodes 151 and the first electrode 131 corresponding to the other second electrode 151, to control the liquid crystal molecules 310 respectively corresponding to the at least two adjacent second electrodes 151 to deflect at different angles, and the difference in the deflection angle of the liquid crystal molecule 310 directly affects the display viewing angle of the display substrate 100. By regulating the voltage differences between different second electrodes 151 and the corresponding first electrodes 131, the display viewing angle of the display substrate 100 may be increased.

It should be noted that since the first electrode 131 is a common electrode, the input voltage thereto is mainly controlled by the input signal transmitted through the common electrode line in the display substrate 100. Under the condition that the input voltages input to two adjacent first electrodes 131 are required to be different, it is only necessary to electrically connect the two adjacent first electrodes 131 to different ones of the common electrode lines and to input different signals to the corresponding common electrode lines, and different values of the voltage difference may be adjusted through the input signals transmitted through the corresponding common electrode lines. The first electrodes with the same input voltage may be electrically connected to the same common electrode line, or electrically connected to different common electrode lines with a same input signal.

In an embodiment, as shown in FIG. 4, after the voltage is input to the second electrode 151 and the first electrode 131, upwardly protruding electric field lines will be generated at the surface of the second electrode 151. As the voltage difference between the second electrode 151 and the first electrode 131 varies, the degree of protrusion and the direction of protrusion of the upwardly protruding electric field lines will also vary. Meanwhile, the liquid crystal molecule 310 located above the second electrode 151 will be deflected at different angles due to the different electric fields applied thereto, thereby obtaining different degrees of orientation of the liquid crystal molecule 310, thereby improving the display viewing angle of the display substrate 100.

In an embodiment of the present disclosure, the display substrate 100 includes the array substrate 110, the first electrode layer 130, the insulation layer 140, and the second electrode layer 150 sequentially arranged in the vertical direction. The first electrode layer 130 includes the plurality of first electrodes 131 arranged spaced apart from each other, and at least two adjacent ones of the first electrodes 131 are insulated from each other. The second electrode layer 150 includes the plurality of second electrodes 151 arranged spaced apart from each other, and the plurality of second electrodes 151 are arranged in a one-to-one correspondence with the plurality of first electrodes 131. In an embodiment of the present disclosure, the first electrode layer 130 is disposed between the array substrate 110 and the insulation layer 140, and at least two adjacent first electrodes 131 are insulated from each other. Therefore, different voltages may be input to the at least two adjacent first electrodes 131. Different voltage differences are formed between the at least two adjacent first electrodes 131 and the corresponding second electrodes 151 and thus different electric fields may be formed therebetween, thereby controlling the corresponding liquid crystal molecule 310 to deflect at different angles, to improve the viewing angle of the display substrate 100.

Alternatively, the display substrate 100 includes a color photoresist layer 120 located between the array substrate 110 and the first electrode layer 130. That is, the first electrode 131 and the second electrode 151 are arranged at a same side of the color photoresist layer 120 and are separated by the insulation layer 140. The insulation layer 140 may include a resin material such as polyfluoroalkoxy (PFA), and the conductivity of the insulation layer 140 is greater than that of the color photoresist layer 120. Compared with respectively arranging the first electrode 131 and the second electrode 151 respectively at opposite sides of the color photoresist layer 120, the above arrangement in the embodiment of the present disclosure enables the first electrode 131 and the second electrode 151 to perform a normal operation at a relatively lower voltage, thereby reducing the operation energy consumption of the display substrate 100.

The color photoresist layer 120 includes a plurality of color photoresists, and the plurality of color photoresists include a red color photoresist, a green color photoresist, and a blue color photoresist. The plurality of color photoresists are arranged in a one-to-one correspondence with the plurality of first electrodes 131, and the first electrodes 131 corresponding to at least two adjacent ones of the color photoresists having different colors are insulated from each other, that is, the color photoresist, the first electrode 131 and the second electrode 151 are arranged in correspondence. By adjusting the input voltage applied to the first electrode 131 to adjust the voltage difference generated between the first electrode 131 and the second electrode 151, the deflection angle of the liquid crystal molecule 310 above the corresponding second electrode 151 may be controlled, thereby adjusting the light emission angle and the transmittance of the corresponding color photoresist, to improve the color deviation of the display substrate 100.

In some embodiments, the first electrodes 131 corresponding to any two adjacent color photoresists of different colors are insulated from each other, that is, the input voltages applied to the first electrodes 131 respectively corresponding to the red color photoresist, the green color photoresist, and the blue color photoresist are different from each other, so that the deflection angles of the liquid crystal molecule 310 above the second electrodes 151 respectively corresponding to the different color photoresists are different from each other, thereby adjusting the light emission angle and the transmittance of the corresponding color photoresist.

In other embodiments, the first electrodes 131 corresponding to at least two color photoresists of the same color are insulated from each other, that is, the input voltages applied to the first electrodes 131 corresponding to the at least two color photoresists of the same color may be set to be different from each other. That is, the input voltages corresponding to the color photoresists of the same color may be controlled separately, to facilitate separate adjustments according to the actual color deviation of different display regions, to improve the overall display quality of the display substrate 100.

In some other embodiments, the first electrodes 131 corresponding to at least two color photoresists of the same color are electrically connected to each other, that is, the input voltages applied to the first electrodes 131 corresponding to the at least two color photoresists of the same color may be set to be the same. Therefore, the input voltages applied to the first electrodes 131 corresponding to the color photoresists of the same color may be controlled synchronously, to simplify the signal input method for the first electrode 131, thereby simplifying the structural design method and the signal input method of the display substrate 100, and thereby reducing the manufacturing difficulty and production cost.

It should be noted that, in actual practice, for the voltage difference between the first electrode 131 and the second electrode 151, the magnitude relationship of the voltage differences corresponding to the red color photoresist, the green color photoresist, and the blue color photoresist may be selected and adjusted according to the actual display requirement of the display substrate 100. That is, the magnitude relationship of the input voltage applied to the corresponding first electrodes 131 corresponding to the red color photoresist, the green color photoresist and the blue color photoresist may be selected and adjusted according to the actual display requirement of the display substrate 100, and the present disclosure is not limited hereto, as long as screen color points on the screen of the display substrate 100 are close to or reach standard color points to ensure the display quality of the display substrate 100.

In an embodiment, when the voltages are to be input to the respective first electrodes 131, the input voltages to be applied to the first electrodes 131 respectively corresponding to the red color photoresist, the green color photoresist, and the blue color photoresist may be adjusted respectively according to the difference between the actual screen color point and the standard color point, so that the liquid crystal molecules 310 above the second electrodes 151 corresponding to the red color photoresist, the green color photoresist and the blue color photoresist may obtain different degrees of orientation of the liquid crystal molecule 310, and then the different transmittances are obtained accordingly. Therefore, the screen color point approaches or reaches the standard color point, to improve the color deviation.

Alternatively, any two adjacent first electrodes 131 are insulated from each other, that is, the input voltages to be applied to any two adjacent first electrodes 131 may be separately controlled. Therefore, the driving force and the action direction of the electric field generated between one of the any two adjacent second electrodes 151 and the first electrode 131 corresponding to the second electrode 151 is different from the driving force and the action direction of the electric field generated between other of the any two adjacent second electrodes 151 and the first electrode 131 corresponding to the other second electrode 151, to control the liquid crystal molecules 310 respectively corresponding to the any two adjacent second electrodes 151 to deflect at different angles due to different electric fields corresponding to the any two adjacent second electrodes 151, thereby obtaining different degrees of orientation of the liquid crystal molecule 310, thereby improving the display viewing angle of the display substrate 100.

It should be noted that, although two adjacent first electrodes 131 that are spaced apart are insulated from each other in some embodiments, the two first electrodes 131 that are spaced apart may be electrically connected to each other in other some embodiments. The specific arrangement may be adjusted according to the actual display requirements, and the present disclosure is not limited hereto, as long as the display viewing angle of the display substrate 100 may be effectively improved.

It should be noted that, in the embodiment of the present disclosure, the voltage difference formed between one of two adjacent second electrodes 151 and the corresponding first electrode 131 is disposed to be different from the voltage difference formed between other one of two adjacent second electrodes 151 and the corresponding first electrode 131 by regulating the voltage input to the first electrodes 131. This is because the first electrode 131 is a common electrode, and the input voltage applied to the first electrode 131 is transmitted through the common electrode line in the display substrate 100. When adjusting the input voltages applied to two adjacent first electrodes 131, the two adjacent first electrodes 131 are electrically connected to different ones of the common electrode lines and different signals are respectively input to the different ones of the common electrode lines.

The second electrode 151 is a pixel electrode, which is electrically connected to the source or drain of the thin film transistor. When the signal is transmitted to the second electrode 151, it is necessary to ensure that the thin film transistor connected to the second electrode 151 may be turned on by the input signal. The turn-on of the thin film transistor is controlled by the scan line and the data line in the display substrate 100, and the scan line is usually disposed to connect the thin film transistors located in a same row, and the data line is usually disposed to connect the thin film transistors located in a same column. Under the condition that the input voltages applied to the two adjacent second electrodes 151 are different from each other, the arrangement and connection of the corresponding thin film transistors will be relatively complicated, and the signal input method thereof will be more complicated. Therefore, in an embodiment of the present disclosure, by adjusting the voltage input to the first electrode 131, the voltage difference between one of the two adjacent second electrodes 151 and the corresponding first electrode 131 is different from the voltage difference between other one of the two adjacent second electrodes 151 and the corresponding first electrode 131, thereby simplifying the design method for the structure and signal input method of the display substrate 100, and reducing the manufacturing difficulty and production cost.

Alternatively, as shown in FIG. 1, the second electrode 151 includes a main electrode 1511 and branch electrodes 1512 that are connected with each other. A plurality of domains 1513 are enclosed and surrounded by each of the at least one of the main electrodes 1511. That is, the main electrode 1511 is in a “+” shape or a square block shape. The branch electrodes 1512 are located in the domain 1513 and connected to the main electrode 1511, and the branch electrode 1512 in one of the two adjacent domains 1513 forms an angle with the branch electrode 1512 in other one of the two adjacent domains 1513. That is, the main electrode 1511 and the branch electrodes 1512 are in the shape of British “Union Jack” as a whole. The branch electrodes 1512 extending in different directions form electric fields having different action directions with the first electrodes 131 corresponding to the branch electrodes 1512, so that the corresponding liquid crystal molecule 310 is oriented in different directions, and the display effects in all directions tend to be uniform and even.

An orthographic projection of the first electrode 131 on the array substrate 110 at least covers an orthographic projection of the main electrode 1511 of the second electrode 151 corresponding to the first electrode 131 on the array substrate 110 (the dotted line in FIG. 1 represents the outline of the first electrode, and the first electrode is stacked under the second electrode). That is, the first electrode 131 is at least arranged corresponding to the main electrode 1511 of the corresponding second electrode 151. The first electrode 131 at least overlaps the main electrode 1511 of the second electrode 151 corresponding to the first electrode 131 in the vertical direction. Since the liquid crystal molecules 310 located above the branch electrodes 1512 in different domains 1513 have been oriented in different directions, the directions along which the light is transmitted through the liquid crystal molecules 310 are also different, and the display viewing angle has been improved to a certain extent. By arranging the first electrode 131 corresponding to the main electrode 1511 in the second electrode 151, the display viewing angle may be further improved. Meanwhile, the use of the first electrode 131 may be reduced, and the difficulty of manufacturing the first electrode 131 may be reduced.

In some embodiments, as shown in FIG. 1 and FIG. 3, a plurality of hollow regions 132 are formed in each of at least one of the plurality of the first electrodes 131, and the plurality of hollow regions 132 are arranged in one-to-one correspondence to the plurality of domain regions 1513 in the second electrodes 151. That is, when the first electrode layer 130 is manufactured, in the process of patterning the first electrode layer 130, while forming the plurality of first electrodes 131, a hole is directly formed in the first electrode 131 to form the hollow region 132, and the hollow region 132 corresponds to the domain region 1513 of the second electrode 151. That is, the hollow region 132 corresponds to the region where the branch electrode 1512 in the second electrode 151 is located. This arrangement may ensure that a voltage difference is formed between the second electrode 151 and the first electrode 131 to control the deflection angle of the liquid crystal molecule 310. Meanwhile, the arrangement of the hollow region 132 may effectively improve the aperture ratio and the penetration ratio of the display substrate 100, to further improve the display effect of the display substrate 100.

In addition, by forming a hollow region 132 in the first electrode 131, the first electrode 131 partial covers the corresponding second electrode 151 in the vertical direction to form a covered area where a portion of the first electrode 131 covers the second electrode 151 and an uncovered area where a remaining portion of the first electrode 131 does not cover the second electrode 151, and the deflection angle of the liquid crystal molecule 310 in the covered area is different from that in the uncovered area. In the case that one of the second electrode 151 is divided into four domains 1513, the liquid crystal molecule 310 above the second electrode 151 may have eight areas of different degrees of orientations of the liquid crystal molecule 310, to improve the display viewing angle.

In other embodiments, a plurality of branch electrodes 1512 are arranged in parallel in each domain 1513. The plurality of branch electrodes 1512 in each domain 1513 are arranged in parallel with each other and form a certain angle with the main electrode 1511 connected thereto. There is a spacing between two adjacent branch electrodes 1512, and in the vertical direction, the hollow region 132 in the first electrode 131 is arranged correspondingly to and overlaps the spacing between two adjacent branch electrodes 1512 in the second electrode 151 corresponding to the first electrode 131. In other words, the first electrode 131 has a similar structure to the corresponding second electrode 151. The first electrode 131 is arranged correspondingly to and overlaps the main and branch electrodes 1511 and 1512 in the corresponding second electrode 151 in the vertical direction, so that the electric field lines may be formed between the main and branch electrodes 1511 and 1512 and the corresponding first electrode 131. By controlling the input voltage applied to the first electrode 131, the liquid crystal molecule 310 above the main electrode 1511 and the branch electrodes 1512 of the second electrode 151 may be deflected to different angles, to further improve the display viewing angle of the display substrate 100.

In some other embodiments, the orthographic projection of the first electrode 131 on the array substrate 110 covers the orthographic projections of the main electrode 1511 and the branch electrode 1512 of the corresponding second electrode 151 on the substrate. That is, the first electrode 131 overlaps both the main electrode 1511 and the branch electrode 1512 of the second electrode 151 in the vertical direction. Under the condition that the first electrode 131 has a structure similar to that of the second electrode 151, the first electrode 131 may cover the edges of both the main electrode 1511 and the branch electrode 1512 of the second electrode 151, thereby facilitating the formation of corresponding electric field lines at the edges of the main electrode 1511 and the branch electrode 1512 of the second electrode 151. The electric field lines with different protrusion degrees and protrusion angles at the edges will affect the liquid crystal molecule 310, thereby causing the liquid crystal molecule 310 to deflect at different angles under the effect of the different electric fields applied thereto.

The first electrode 131 and the second electrode 151 in an embodiment of the present disclosure may be transparent electrodes, that is, the first electrode layer 130 is a transparent storage capacity and shielding layer (Transparent Storage capacity and Shielding Layer, TSS), and the first electrode 131 may be used as both a common electrode and a shielding layer. The first electrode 131 is a transparent electrode. Therefore, compared with providing a metal shielding layer of a single layer in the display substrate 100, this arrangement may increase the aperture ratio of the display substrate 100, improve the transmittance, and thus improve the display effect of the display substrate 100.

In addition, an embodiment of the present disclosure also provides a liquid crystal display panel, which includes a display substrate. The specific structure of the display substrate refers to the above embodiment. Since the liquid crystal display panel adopts all the technical solutions of all the above embodiments, it has at least all the beneficial effects brought by the technical solutions of the above embodiments, which will not be repeated here.

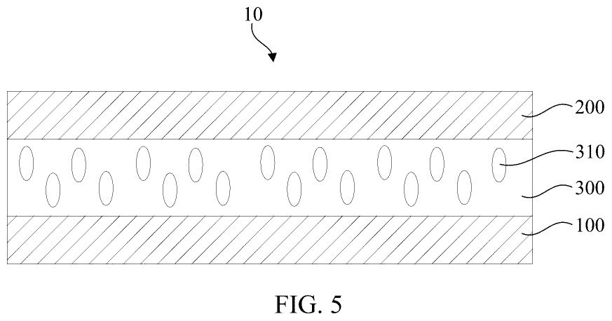

As shown in FIG. 5, the liquid crystal display panel 10 includes a display substrate 100, an opposing substrate 200, and a liquid crystal layer 300. The opposing substrate 200 is arranged opposite to the display substrate 100. The opposing substrate 200 is located at a side of the second electrode layer 150 in the display substrate 100 away from the array substrate 110, and the liquid crystal layer 300 is filled between the display substrate 100 and the opposing substrate 200.

A storage capacitor is formed between the first electrode 131 and the second electrode 151 of the display substrate 100, and a first electric field is formed between the first electrode 131 and the second electrode 151 to act on the liquid crystal molecule 310 in the liquid crystal layer 300. Meanwhile, a second electric field is formed between the second electrode 151 and the opposing electrode in the opposing substrate 200 to act on the liquid crystal molecule 310 in the liquid crystal layer 300. The first electric field and the second electric field commonly cause the liquid crystal molecule 310 to undergo corresponding deflection to adjust the transmittance and display viewing angle of the display panel.

In an embodiment of the present disclosure, the display substrate 100 includes an array substrate 110, a first electrode layer 130, an insulation layer 140, and a second electrode layer 150 sequentially arranged in the vertical direction. The first electrode layer 130 includes a plurality of first electrodes 131 arranged apart from each other, and at least two adjacent first electrodes 131 are insulated from each other. The second electrode layer 150 includes a plurality of second electrodes 151 arranged apart from each other, and the plurality of second electrodes 151 are arranged in a one-to-one correspondence with the plurality of first electrodes 131. In an embodiment of the present disclosure, the first electrode layer 130 is disposed between the array substrate 110 and the insulation layer 140, so that at least two adjacent first electrodes 131 are insulated from each other. Therefore, different voltages may be input to the two first electrodes 131, respectively, and thus the two first electrodes 131 may form different voltage differences and thus different electric fields with the corresponding second electrodes 151, thereby controlling the liquid crystal molecule 310 corresponding to the two first electrodes 131 to deflect to different angles, to improve the display viewing angle of the liquid crystal display panel 10.

In an embodiment of the present disclosure, as shown in FIG. 4, after the voltage is applied to the second electrode 151 and the first electrode 131, upwardly protruding electric field lines will be generated from the surface of the second electrode 151. As the voltage difference between the second electrode 151 and the first electrode 131 varies, the degree of protrusion and the direction of protrusion of the upwardly protruding electric field lines therebetween will vary. The electric field lines will also be generated between the opposing substrate 200 and the second electrode 151. Meanwhile, the liquid crystal molecule 310 between the opposing substrate 200 and the second electrode 151 will be deflected at different angles due to the different electric fields applied thereto, thereby obtaining different degrees of orientation of the liquid crystal molecule 310, thereby improving the display viewing angle of the display substrate 100.

It should be noted that the application of the liquid crystal display panel 10 in the embodiment of the present disclosure is widely used in various displays such as televisions, computers, mobile phones, and foldable and rollable display screens, lighting display devices, wearable devices such as smart bracelets and smart watches, all of which are within the scope of the application of the liquid crystal display panel 10 in an embodiment of the present disclosure.

The above is a detailed description of a display substrate and a liquid crystal display panel according to an embodiment of the present disclosure. Specific examples are provided herein to illustrate the principles and implementation methods of the present disclosure. The description of the above embodiments is only used to help understand the method and the core idea of the present disclosure. Meanwhile, for those skilled in the art, there will be changes in the specific implementation method and application scope of the presented embodiments of the present disclosure. In sum, the content of this specification should not be understood as a limitation on the present disclosure.

What is claimed is:

1. A display substrate, applied to a liquid crystal display panel, and the display substrate comprises:
an array substrate;
a first electrode layer disposed at a side of the array substrate, wherein the first electrode layer comprises a plurality of first electrodes arranged spaced apart from each other, and at least two adjacent ones of the plurality of first electrodes are insulated from each other;
an insulation layer disposed at a side of the first electrode layer away from the array substrate; and
a second electrode layer disposed at a side of the insulation layer away from the first electrode layer, wherein the second electrode layer comprises a plurality of second electrodes arranged spaced apart from each other, and the plurality of second electrodes are arranged in one-to-one correspondence with the plurality of first electrodes.

2. The display substrate according to claim 1, wherein the display substrate comprises a color photoresist layer, the color photoresist layer is located between the array substrate and the first electrode layer, the color photoresist layer comprises a plurality of color photoresists, the plurality of color photoresists are arranged in a one-to-one correspondence with the plurality of first electrodes, and ones of the plurality of first electrodes corresponding to at least two adjacent ones of the plurality of color photoresists having different colors are insulated from each other.

3. The display substrate according to claim 2, wherein ones of the plurality of first electrodes corresponding to any two adjacent ones of the color photoresists having different colors are insulated from each other.

4. The display substrate according to claim 2, wherein ones of the plurality of first electrodes corresponding to at least two ones of the color photoresists having the same color are insulated from each other.

5. The display substrate according to claim 2, wherein ones of the plurality of first electrodes corresponding to at least two ones of the color photoresists having the same color are electrically connected to each other.

6. The display substrate according to claim 1, wherein the second electrode comprises a main electrode and one or more branch electrodes connected to each other, a plurality of domains are enclosed by the main electrode, the branch electrode is located within at least one of the domains, and the branch electrode in one of two adjacent ones of the domains form an angle relative to the branch electrode in other of the two adjacent ones of the domains, and an orthographic projection of the first electrode on the array substrate at least covers an orthographic projection of the main electrode of the second electrode on the array substrate.

7. The display substrate according to claim 6, wherein a plurality of hollow regions are formed in the first electrode, and the plurality of hollow regions are arranged in a one-to-one correspondence with the plurality of domains in the second electrode.

8. The display substrate according to claim 7, wherein more than one of the one or more branch electrodes are arranged in parallel in the domain, a spacing is provided between two adjacent ones of the one or more branch electrodes, and the hollow region in the first electrode is provided corresponding to the spacing between two adjacent ones of the branch electrodes in the second electrode.

9. The display substrate according to claim 6, wherein an orthographic projection of the first electrode on the array substrate covers the orthographic projections of the main electrode and the branch electrodes of the second electrode on the array substrate.

10. The display substrate according to claim 1, wherein the first electrode and the second electrode are transparent electrodes.

11. A liquid crystal display panel, comprising:
the display substrate according to claim 1;
an opposing substrate, arranged opposite to the display substrate, and located at a side of the second electrode layer of the display substrate away from the array substrate; and
a liquid crystal layer filled between the display substrate and the opposing substrate.

12. The liquid crystal display panel according to claim 11, wherein the display substrate comprises a color photoresist layer, the color photoresist layer is located between the array substrate and the first electrode layer, the color photoresist layer comprises a plurality of color photoresists, the plurality of color photoresists are arranged in a one-to-one correspondence with the plurality of first electrodes, and ones of the plurality of first electrodes corresponding to at least two adjacent ones of the plurality of color photoresists having different colors are insulated from each other.

13. The liquid crystal display panel according to claim 12, wherein ones of the plurality of first electrodes corresponding to any two adjacent ones of the color photoresists having different colors are insulated from each other.

14. The liquid crystal display panel according to claim 12, wherein ones of the plurality of first electrodes corresponding to at least two ones of the color photoresists having the same color are insulated from each other.

15. The liquid crystal display panel according to claim 12, wherein ones of the plurality of first electrodes corresponding to at least two ones of the color photoresists having the same color are electrically connected to each other.

16. The liquid crystal display panel according to claim 11, wherein the second electrode comprises a main electrode and one or more branch electrodes connected to each other, a plurality of domains are enclosed by the main electrode, the branch electrode is located within at least one of the domains, and the branch electrode in one of two adjacent ones of the domains form an angle relative to the branch electrode in other of the two adjacent ones of the domains, and an orthographic projection of the first electrode on the array substrate at least covers an orthographic projection of the main electrode of the second electrode on the array substrate.

17. The liquid crystal display panel according to claim 16, wherein a plurality of hollow regions are formed in the first electrode, and the plurality of hollow regions are arranged in a one-to-one correspondence with the plurality of domains in the second electrode.

18. The liquid crystal display panel according to claim 17, wherein more than one of the one or more branch electrodes are arranged in parallel in the domain, a spacing is provided between two adjacent ones of the one or more branch electrodes, and the hollow region in the first electrode is provided corresponding to the spacing between two adjacent ones of the branch electrodes in the second electrode.

19. The liquid crystal display panel according to claim 16, wherein an orthographic projection of the first electrode on the array substrate covers the orthographic projections of the main electrode and the branch electrodes of the second electrode on the array substrate.

20. The liquid crystal display panel according to claim 11, wherein the first electrode and the second electrode are transparent electrodes.
